(19) United States
(12) Patent Application Publication
(10) Pub. No.: US 2016/0176357 A1
(43) Pub. Date: Jun. 23, 2016

(54) THERMOPLASTIC COMPOSITE RETROFIT PANEL ASSEMBLY FOR PERSONAL ENTERTAINMENT DEVICE MOUNT SYSTEM

(71) Applicant: Reliant Worldwide Plastics, LLC, Plano, TX (US)

(72) Inventor: William H. Maslakow, Lewisville, TX (US)

(73) Assignee: Reliant Worldwide Plastics, LLC, Plano, TX (US)

(21) Appl. No.: 14/979,161

(22) Filed: Dec. 22, 2015

Related U.S. Application Data
(60) Provisional application No. 62/096,278, filed on Dec. 23, 2014.

(51) Int. Cl. B60R 11/02; B60R 7/04; F16B 47/00; F16B 1/00; F16M 13/02

(52) U.S. Cl. CPC B60R 11/02; F16B 1/00; F16M 13/02; F16B 47/00; F16B 47/006; F16B 47/003; B60R 7/043; F16B 2001/0035; B60R 2011/0015

(57) ABSTRACT

Disclosed embodiments relate to personal entertainment mount systems and methods, including methods and systems for retrofitting a personal entertainment mount onto existing seats having an entertainment display shroud for use with an in-flight entertainment display device. The display mount may be operable to allow a variety of different personal entertainment devices to be removably mounted onto a seat back.

### CROSS-REFERENCE TO RELATED APPLICATIONS

This patent application claims priority to, and incorporates by reference for any purpose the entire disclosure of, U.S. Provisional Patent Application No. 62/096,278, filed Dec. 23, 2014. U.S. patent application Ser. No. 14/719,668, filed May 22, 2015 is incorporated herein by reference.

### BACKGROUND

1. Field of the Invention

The present application relates generally to seat back device retention systems and methods and more particularly, but not by way of limitation, to a personal entertainment device mount retrofit for seat backs.

2. History of Related Art.

While many current airlines provide a seatback mounted screen (e.g. in-flight entertainment) for each seat (allowing passengers/users in each seat to view the screen, for entertainment purposes for example), such permanently mounted screens may soon become obsolete given the explosion in handheld personal devices (such as iPads and other tablet computers or smart phones, for example). Thus, it may be advantageous in the near future to remove the permanently mounted screens in aircraft. However, passengers still might appreciate the option to have a mounted screen (rather than having to hold their device the entire time during use, for example). Thus, Applicant has designed personal entertainment device mount assembly embodiments, which may allow a passenger to removably mount their own device onto the seat back in front of them. One challenge for such embodiments, however, is that there can be a wide array of different devices (which, for example, might have different size and shape configurations). Thus, disclosed embodiments try to be accommodating, by having an adjustable feature for retention of such devices.

Additionally, in the commercial aircraft industry, weight and safety are important issues. Even non-structural and non-critical elements like an entertainment device mount attached to a seat back on commercial aircraft should be designed with these issues in mind For example, a weight savings on each device mount can add up to fairly significant weight savings for the aircraft as a whole, which in turn may reduce fuel expenditure and thereby provide a cost savings. Even in the case of device mounts, any such weight reduction must not adversely affect strength. Typically, governmental rules and regulations may specify strength requirements for aircraft elements and, at the very least, strength issues may impact durability and expected lifespan of the element, such as a device mount. Of course, cost is also a driving factor in the commercial airline industry, so low cost manufacturing techniques may be important as well. Disclosed embodiments relate to improved entertainment device mount embodiments that may address one or more of these issues.

### SUMMARY

In one aspect, the present invention relates to a retrofit mount assembly for a personal entertainment device. The retrofit mount assembly includes a retrofit panel coupled to a seat back and a mount plate removably coupled to the retrofit plate. A rotatable bracket element is coupled to the mount plate. An enclosure is coupled to the rotatable bracket element. The enclosure includes a plurality of adjustable retention members slidably disposed in the enclosure. At least one retention member of the plurality of adjustable retention members is linearly adjustable to facilitate receipt of a personal device by the enclosure.

In another aspect, the present invention relates to a method of assembling a retrofit mount assembly for a personal entertainment device. The method includes securing a retrofit panel to a seat back and removably attaching a mount plate to the retrofit panel. The mount plate is coupled to an enclosure via a rotatable bracket. A retention member is adjusted to facilitate receipt of the personal entertainment device into the enclosure.

### BRIEF DESCRIPTION OF THE DRAWINGS

For a more complete understanding of the present invention and for further objects and advantages thereof, reference may now be had to the following description taken in conjunction with the accompanying drawings in which:

FIG. 1 is an exploded perspective view of a mounting assembly according to an exemplary embodiment;

FIG. 2A is a side view of the mounting assembly in a collapsed state according to an exemplary embodiment;

FIG. 2B is a side view of the mounting assembly in an extended state according to an exemplary embodiment;

FIG. 3A is a rear view of a mounting enclosure according to an exemplary embodiment;

FIG. 3B is a side view of the mounting enclosure according to an exemplary embodiment;

FIG. 4 is a cutaway view of the mounting enclosure illustrating internal components thereof according to an exemplary embodiment;

FIG. 5A is a side view of a mounting button according to an exemplary embodiment;

FIG. 5B is an exploded perspective view of an interface between the mounting button and an aperture according to an exemplary embodiment;

FIG. 5C is a cross-sectional view of the interface between the mounting button and an aperture according to an exemplary embodiment; and

FIG. 6 is a cutaway view of the mounting enclosure having a plurality of levers illustrating internal components thereof according to an exemplary embodiment;

FIG. 7 is an exploded view showing exemplary current seats with in-flight entertainment devices built-in according to an exemplary embodiment;

FIG. 8 is a perspective view of a retrofit embodiment in which a retrofit panel is fitted in place within an opening in an in-flight entertainment display shroud on a seat back according to an exemplary embodiment;

FIG. 9 is an exploded view of the retrofit embodiment of FIG. 8 according to an exemplary embodiment;

FIG. 10A is a cross-sectional view of a removably-mounted device mount in place and attached to a retrofit panel according to an exemplary embodiment;

FIG. 10B is an exploded cross-sectional view of the device mount and retrofit panel of FIG. 10A according to an exemplary embodiment;

FIG. 11 is a perspective view of a device mount attached via rare-Earth magnets to a retrofit panel according to an exemplary embodiment;

FIG. 12 is an exploded view of the retrofit panel of FIG. 11 according to an exemplary embodiment;

FIG. 13 is an exploded view of the retrofit panel of FIG. 11 showing a rear side of the retrofit panel according to an exemplary embodiment;

FIG. 14 is a perspective view of a device mount attached via suction cups to a retrofit panel according to an exemplary embodiment; and

FIG. 15 is an exploded view of the retrofit panel of FIG. 14 according to an exemplary embodiment.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example;

The terms “about” or approximately” or the like, when used with a number, may mean that specific number, or alternatively, a range in proximity to the specific number, as understood by persons of skill in the art field; and

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

Some disclosed embodiments may generally relate to an extension of concepts of embodiments previously disclosed in related provisional U.S. patent application 61/711,567 and related U.S. non-provisional patent application Ser. No. 14/048,840, entitled Thermoplastic Injection Molded Element with Integral Thermoplastic Positioning System for Reinforced Composite Structures, filed respectively Oct. 9, 2012 and Oct. 8, 2013; related U.S. provisional patent application 61/988,080 entitled “Seat Back” and filed May 2, 2014; and related U.S. provisional patent application 62/002,594 entitled “Personal Entertainment Device Mount Assembly for Seat Back” and filed May 23, 2014; which are co-owned and are each hereby incorporated by reference to the extent it does not contradict the express disclosure herein. More specifically, disclosed embodiments may relate to personal entertainment device mount assembly embodiments, which may in some instances be formed using composite materials and/or thermoplastic molded (for example, injection molded) materials (such that disclosed embodiments might be a specific application and/or modification of the previous provisional patent technology).

Some disclosed embodiments may relate to a seat back mounted thermoplastic Personal Entertainment Device Mount, utilized in the commercial aerospace industry, comprised of an injection molded assembly with integral Device Dimension Adjustment to allow the retention of numerous dimensioned Personal Entertainment Devices.

Such device mount assembly embodiments may further be comprised of thermally formed thermoplastic encapsulated unidirectional or weave carbon or glass reinforced composite structures with integral homogeneous injection molded thermoplastic support elements that provide a portion of the structural requirements and reduce device mount assembly weight. Such device mount assembly embodiments may further be comprised of integral thermoplastic injection molded Elastomeric Elements that provide damage-free personal device retention. Typically, such device mount assembly embodiments may further be comprised of integral thermoplastic injection molded elements that provide User Selected Device Dimension Adjustment feature.

In some embodiments, the device dimension adjustment feature may further be comprised of an Integral Rotatable Locking User Adjustment to maintain the user selected device dimension during initial device installation. Such device dimension adjustment integral rotatable locking feature may additionally permit the removal of the personal device upon the completion of use.

Furthermore, in some embodiments, the device mount may further be comprised of injection molded attachable rotatable elements that provide user selectable field of and distance of view during the reclining of the forward facing seat assembly. Such attachable rotatable elements may further be comprised of integral restrictive rotational pivot bearings that permit retention of the user selected position during use and during the environment of air travel.

In some embodiments, the attachable rotatable elements may further be comprised of at least one element with integral Device Mount-to-Seat Back Mounting Buttons for the installation and retention of the device mount to a commercial seat back assembly. The mounting buttons of device may be operable to mount interface with suitable located Mounting Button Apertures located on the forward positioned commercial airline seat back.

In some embodiments, the mounting button apertures may further be comprised of pivoting spring-loaded Aperture Covers, which displace rotationally during the installation of the device mount mounting button, and return to initial position upon removal of the device mount. Such aperture covers may further be comprised of integral thermoplastic injection molded spring deflecting elements that provide resistive pressure to permit aperture cover to return to initial position upon removal of device mount.

Typically, disclosed embodiments may further be comprised of materials that comply with FAR 25.853 and OSU 55/55 when applicable.

Personal entertainment device mount assembly embodiments (which comply to FAR 25.853 and OSU 55/55), may be comprised of integral injection molded thermoplastic elements and thermoplastic reinforced composite structures, providing damage free locking user selectable dimension device retention and user selectable field of and distance of view, and a plurality of integral mounting buttons which mate install into a commercial airline seat back assembly with rotatable integral spring actuated closable mounting button aperture covers to eliminate user pinch injury.

Some disclosed embodiments may be comprised of chemical and molecular compatible thermoplastic resins throughout the assembly, creating an infinite number of homogenous connective attachments that provide additional consistent strength, dimensional stability and rigidity.

Some disclosed embodiments may provide increased mechanical load bearing capabilities provided by the integral formed thermoplastic carbon or glass reinforced composite element with the integral injection molded carbon or glass fiber reinforced thermoplastic support structure by the infinite number of homogeneous connective interfaces.

And in some embodiments, the integral formed thermoplastic encapsulated carbon or glass reinforced composite element may comprise multiple weave patterns, multiple layers and layer orientations to provide the optimum performance for the requirement load application.

Disclosed embodiments may reduce the current weight of a comparable personal entertainment device mount assembly by the use of high strength to weight ratio thermoplastic materials and composites.

Disclosed embodiments may eliminate scrap rejections inherent to current thermoset epoxy assemblies, including delamination and reinforcement disassociation.

Disclosed embodiments generally may relate to personal entertainment device mount assemblies to be used with seat backs for aircraft. In some embodiments, the personal entertainment device mount assembly may be removably attached to a seat back. Typically, disclosed elements of a device mount assembly may be formed of one or more layers of composite material (e.g. the elements of the device mount assembly might comprise a composite structure having one or more layers of composite material). Each layer of composite material typically has reinforcing fibers (for example, a weave of reinforcing fibers) located internally, with thermoplastic surrounding it (e.g. atop and below the fibers). For example, the composite material typically would only have reinforcing fibers located internally, for example in a central plane. When multiple layers of composite material (e.g. the same composite material for each layer, each at least having the same thermoplastic material encapsulating or sheathing the reinforcing fibers) form the elements of assembly, the multiple layers of composite typically would be thermally and/or homogeneously joined (or otherwise consolidated) together to form a unitary structure with homogeneous connective interface throughout. Typically, the one or more layers of composite material may be shaped into the form of the elements of the device mount assembly, configured to attach to the rear of an airline seat back assembly.

In some embodiments, one or more of the elements of the device mount assembly might be injection molded onto the composite material, and since the elements typically would be formed of the same thermoplastic as the composite material, the elements typically would be thermally and/or homogeneously attached/affixed to the composite material. Specific embodiments related to the figures will be discussed in more detail below.

For example, composite material typically may comprise an array of reinforcing fibers (for example, carbon and/or graphite fibers and/or glass and/or aramid, perhaps typically with carbon microscopic crystals aligned parallel to the longitudinal axis of the carbon fibers, for example) aligned in a precise orientation, and a thermoplastic material (for example, a sheathing) located about the array of reinforcing fibers (for example, encapsulating the reinforcing fibers). The array of fibers may be a weave pattern, for example, a five harness satin weave, in some embodiments, while in other embodiments the array of fibers may be aligned uni-directionally in a parallel linear pattern. In some embodiments, the composite might be provided in pre-defined and/or pre-formed solid three dimensional geometries, such as a solid sheet, which can then be shaped according to the needs of the specific element (for example, by heat forming and/or cutting). Since such a composite material typically may be a rigid solid at room temperature (and only softens sufficiently to allow shaping such as bending or twisting at elevated temperatures), there would typically be no need for an external frame (for example, in addition to any mold) to hold the composite in the desired shape and/or position while forming encapsulating thermoplastic about the composite using injection molding in order to form any desired additional element (in other words, once the composite sheet material is shaped as desired for the particular device mount assembly and has cooled to room temperature, it is a rigid solid that will independently hold the shape in question, and should not need any framework to hold its shape within the mold for forming thermoplastic elements onto the composite).

In other embodiments, the composite material might be formed by layering thermoplastic film and reinforcing fiber cloth or weave, which would then be consolidated (for example via heat and/or compression) into a unitary composite material with reinforcing fibers located between two thermoplastic layers. For example, each composite material layer might comprise two thermoplastic film layers sandwiching or surrounding a layer of reinforcing fiber (for example a weave of reinforcing fiber). The one or more layers of composite might then be placed on a press mold for the shape of a personal entertainment device mount assembly element, with the press mold then being used to consolidate the one or more layers of composite (e.g. the one or more layer of reinforcing fibers with the two or more layers of thermoplastic (e.g. thermoplastic film)), thereby forming the composite device mount assembly element structure.

Typically, the array of fibers of the composite material would be located (only) near the center (thickness) of the composite material (e.g. in a central plane), with thermoplastic material located atop and beneath the array of fibers. In other words, the composite material would typically have all of the reinforcing fibers located in a single/central plane, with the rest of the thickness of the composite material being formed of thermoplastic material. Regardless, the composite typically might provide approximately consistent fiber distribution (and perhaps orientation in some embodiments) throughout the element, so that it can provide precise and consistent/reproducible structural and/or mechanical support. While many embodiments may be formed of such composite material (with or without encapsulating thermoplastic, which might be homogeneously attached thereto), it should be understood that the specific material used to form on or more elements of exemplary mount embodiments is optional (such that other material might also be used in various embodiments).

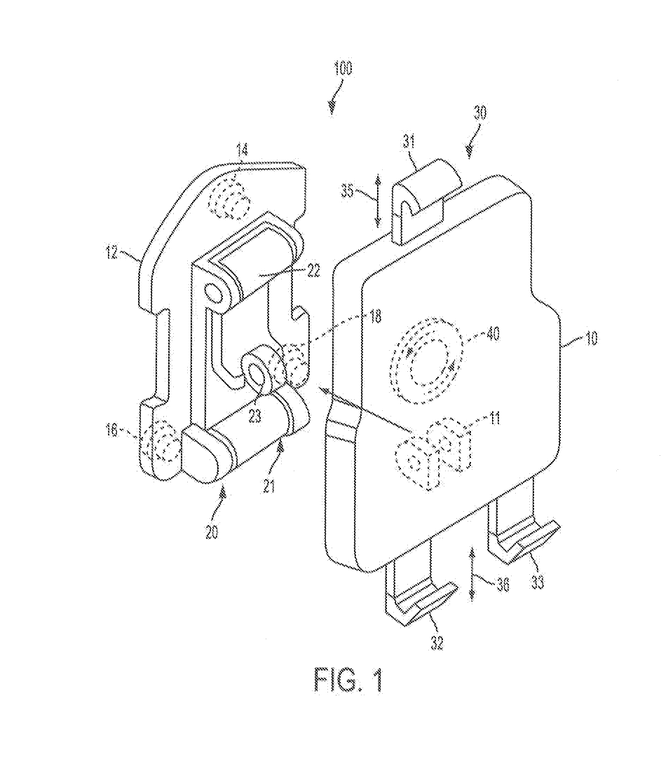

FIG. 1 illustrates (with exploded perspective view) an exemplary personal entertainment device mount assembly 100, with a molded enclosure 10 coupled or mounted to a mount plate 12, wherein the mount plate 12 may attach to a seat back via one or more mount buttons 14, 16, and 18. The mount plate 12 may comprise rotatable bracket elements 20, wherein the elements may comprise a first rotatable bracket 21 and a second rotatable bracket 22. The molded enclosure 10 may mount to the mount plate 12 via a bracket 11 that fits with the second rotatable bracket 22 via a mount 23 (for example, with a bolt passing through bracket 11 and mount 23 to form a pivot attachment), wherein the mount 23 may rotate within the bracket 11. The molded enclosure 10 may comprise a device retention system 30 that comprises one or more (and typically a plurality of) elastomeric retention elements 31, 32, and 33 operable to hold a personal entertainment device in place against the front face of the molded enclosure 10. Typically, the retention elements 31, 32, and 33 would include at least two retention elements, with at least one retention element located on each of two opposing sides (for example on the top and bottom). In a typical embodiment, the retention elements 31, 32, and 33 comprise a thermoplastic rigid material such as, for example, an injection-molded material, a composite material, or a combination thereof with integral elastomeric elements. The retention elements 31, 32, and 33 may be operable to move outward from the molded enclosure, for example moving in a vertical direction as illustrated by arrows 35 and 36, in the embodiment of FIG. 1. Such (vertical) movement of the retention elements 31, 32 and 33 may be controlled by a dimension adjustment feature 40 (typically located on the rear face of the molded enclosure 10). In some embodiments, one or more of the elements of the device mount assembly 100 described above may comprise thermoplastic material and/or composite material.

Thus, the molded enclosure 10 (with retention elements 31, 32, and 33 and dimension adjustment feature 40) may operate to removably fix a device, and the mount plate 12 (with the rotatable bracket elements 20) may allow for repositioning of such a mounted device. In other words, the pivoting attachment of the molded enclosure 10 to the mount plate 12 may allow for a mounted device to be repositioned by a user (for example, if the seat back in front of the user is reclined). Typically, the molded enclosure 10 is coupled to the mount plate 12 in such a way as to provide at least three pivot points for position adjustment.

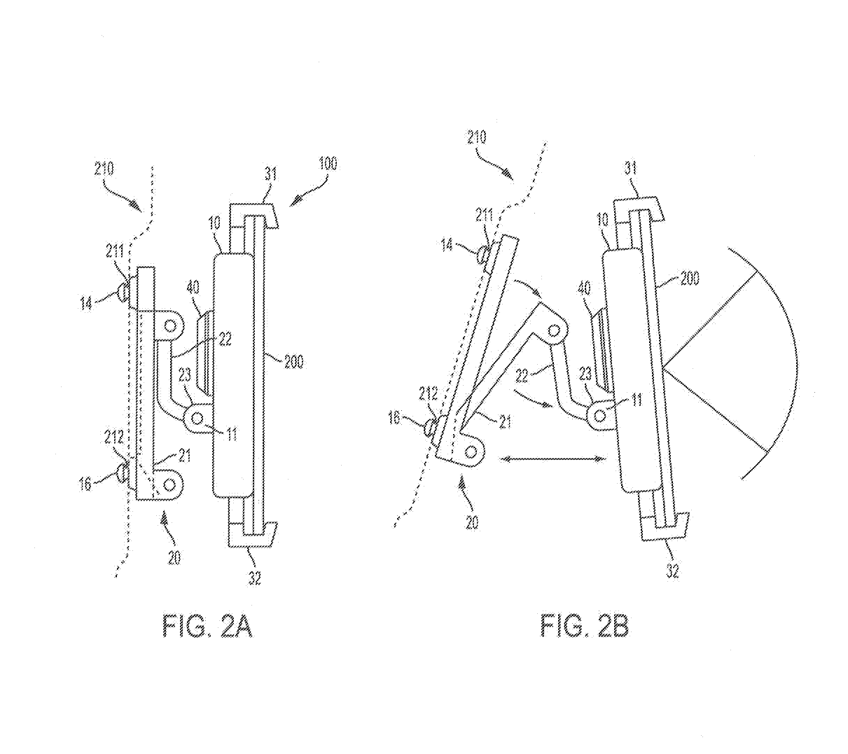

FIG. 2A illustrates an exemplary side view of the device mount assembly 100 of FIG. 1 when the seat back 210 is in an upright position. The device mount assembly 100 may hold a personal entertainment device 200 via the retention elements 31, 32 and 33 (not shown). In the embodiments shown in FIG. 2A, the device mount assembly 100 may be in a “closed” position, wherein the rotatable bracket elements 20 may be in a first “closed” position.

FIG. 2B illustrates an exemplary side view of the device mount assembly 100 when the seat back 210 is in a reclined position. The rotatable bracket elements 20 may be in a second “expanded” position, wherein the first bracket 21 and the second bracket 22 may be operable to rotate/pivot independently to provide a wide range of movement of the molded enclosure 10 to position the personal entertainment device 200 at a desired angle for the user to view. In some embodiments, the rotatable bracket elements may comprise integral restrictive rotational pivot bearings that permit the retention of the user selected position, such as the closed and expanded positions shown in FIGS. 2A-2B, during use and during the environment of air travel.

As shown in FIGS. 2A-2B, the device mount assembly 100 may be attached to the seat back 210 via the one or more mount buttons 14, 16 and 18 (not shown). In some embodiments, the seat back 210 may comprise apertures 211 and 212 operable to interface with the one or more mount buttons 14 and 16. It should be understood, however, that this exemplary mount button embodiment for attaching/affixing the mount plate 12 to a seat back is merely one exemplary means to attach the mount plate 12 to the seat back; and other attachment means are also included within the scope of this disclosure.

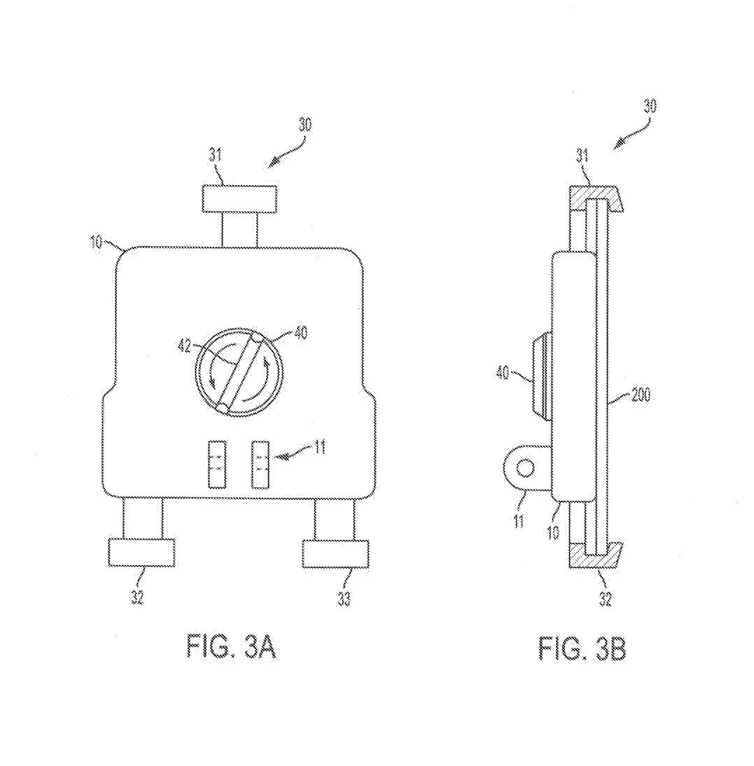

FIGS. 3A-3B illustrate a detailed view of the molded enclosure 10 with the device retention system 30. In some embodiments the dimension adjustment feature 40 may be located above the mount 11 on the rear of the molded enclosure 10, which may allow a user access to the adjustment feature 40 to control the adjustment of the retention elements. The dimension adjustment feature may be operable to move rotationally, and may comprise a handle/knob 42 which may be grasped by a user to rotate the adjustment feature 40. In an exemplary embodiment, a user may place a personal device 200, such as a tablet, within the retention elements 31, 32 and 33. Then the user may rotate the adjustment feature 40 to move the retention elements 31, 32 and 33 inward (for example in a vertical direction), such that the retention elements 31, 32 and 33 fit snuggly around the edges of the personal device 200, as shown in FIG. 3B. The retention elements 31, 32 and 33 may be formed of a material that prevents damage to the personal device 200 when it is held by the retention elements 31, 32 and 33. In some embodiments, the retention elements 31, 32 and 33 may comprise thermoplastic polyurethane (TPU) material and/or composite material.

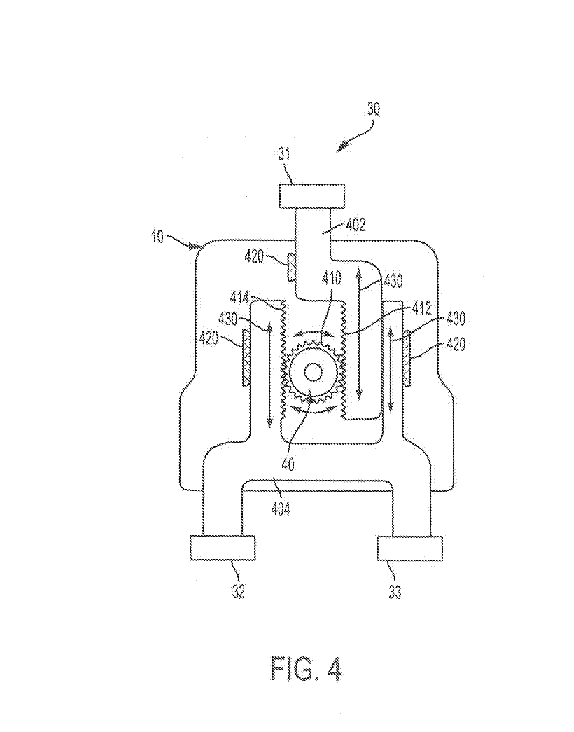

FIG. 4 illustrates a cut-away view of the molded enclosure 10 to better show the inner workings of the retention system 30 within the molded enclosure 10. The retention elements 31, 32 and 33 may be mounted to support pieces 402 and 404. In some embodiments, the retention system 30 may comprise a top support piece 402 and a bottom support piece 404. The support pieces 402 and 404 may be operable to move vertically within the molded enclosure 10, as shown by arrows 430 in FIG. 4. In some embodiments, the support pieces 402 and 404 may move in opposite direction, i.e. when the top support piece 402 is adjusted upward or away from the molded enclosure 10, the bottom support piece 404 is moved downward and also away from the molded enclosure 10. In other words, the support pieces 402 and 404 may both move away from the molded enclosure 10 or toward the molded enclosure 10. In other embodiments, however, one or more of the retention elements and its support piece might be fixed, such that the adjustment only affects some of the retention elements, and their movements with respect to the fixed retention element(s) might allow for securement of the device. In some embodiments, one or more of the support pieces 402 and 404 may comprise teeth 412 and 414, respectively, on at least a portion of their surface operable to interact with teeth 410 located on the outer edge of the adjustment feature 40 (such that the adjustment feature comprises a gear with teeth and the teeth of the support pieces interacts/intermeshes with the gear teeth 410). For example, a rack and pinion gear set might be formed to provide adjustment. The rotation of the adjustment feature 40 may cause the support pieces 402 and 404 to move vertically via the interaction of the teeth 410 of the adjustment feature with the teeth 412 and 414 of the support pieces 402 and 404. The support pieces 402 and 404 may also be held in place with respect to one direction (for example, in a horizontal direction) by guide bearings 420, such that the only movement of the support pieces 402 and 404 is in a single direction (for example, the vertical direction of FIG. 4). In some embodiments, the adjustment feature 40 may comprise a locking element operable to hold the support pieces 402 and 404 in a specific vertical position until it is unlocked. The locking element may prevent the support pieces 402 and 404, and therefore the retention elements 31, 32 and 33, from moving while a personal device is being held by the retention elements 31, 32, and 33. In other embodiments, the adjustment feature 40 may employ some resistance mechanism to securely hold a position (for example, when the device is seated and held by the retention elements). In some embodiments, the elements of the device retention system 30 may comprise thermoplastic material and/or composite material.

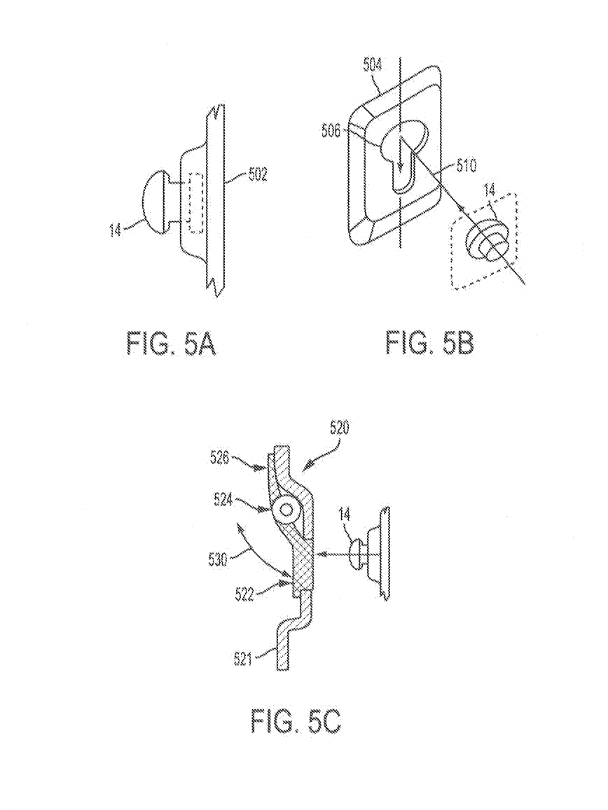

FIG. 5A illustrates a detailed view of an exemplary embodiment of a mount button 14 (for example, the type of mount button shown in FIG. 2 for mounting the mount plate to the seat back). The mount button 14 may be attached to a molded mount bracket 502, which may connect the mount button 14 to the mount plate 12 (of FIG. 1). FIG. 5B illustrates how a mount button 5B may attach to the seat back 210 (of FIGS. 2A-2B), wherein a mount button receptacle 504 may be integrated into (or attached onto) the seat back 210, and the mount button receptacle 504 may comprise an aperture 506 (which may be similar to the apertures 211 and 212 of FIGS. 2A-2B). The aperture 506 may be shaped such that a portion of the button 14 (e.g. the button head) may fit through a portion of the aperture 506 and then slide down and be held in place by a narrower portion of the aperture 506, as illustrated by arrows 510. For example, the aperture 506 might have a key hole shape which is larger toward the top and narrower toward the bottom. The larger portion of the aperture would provide clearance for insertion of the button head, while the narrower (lower) portion of the aperture would be too narrow for the head to pull out (but wide enough for the neck of the button to extend outward). Such a button/aperture design might allow for removable attachment of the mount device to the seat back, with the removable attachment being quick and easy to secure, but also providing secure attachment to fix the mount onto the seat back. The elements of the button receptacle 504 may comprise thermoplastic material and/or composite material.

FIG. 5C illustrates an embodiment of an optional button receptacle 520 which may be formed into a seat back 521 and have a pivoting door to guard against finger pinch. The button receptacle may comprise a door 522 and pivot 524 mechanism, wherein the button 14 may push the door 522 in the direction indicated by arrow 530 about the pivot 524 when the button 14 is inserted into the receptacle 520. In some embodiments, the door 522 may comprise a spring 526 operable to bias the door 522 towards a closed position, such that when the button 14 is removed from the receptacle, the door 522 may pivot back to the position shown in FIG. 5C. The elements of the button receptacle 520 may comprise thermoplastic material and/or composite material.

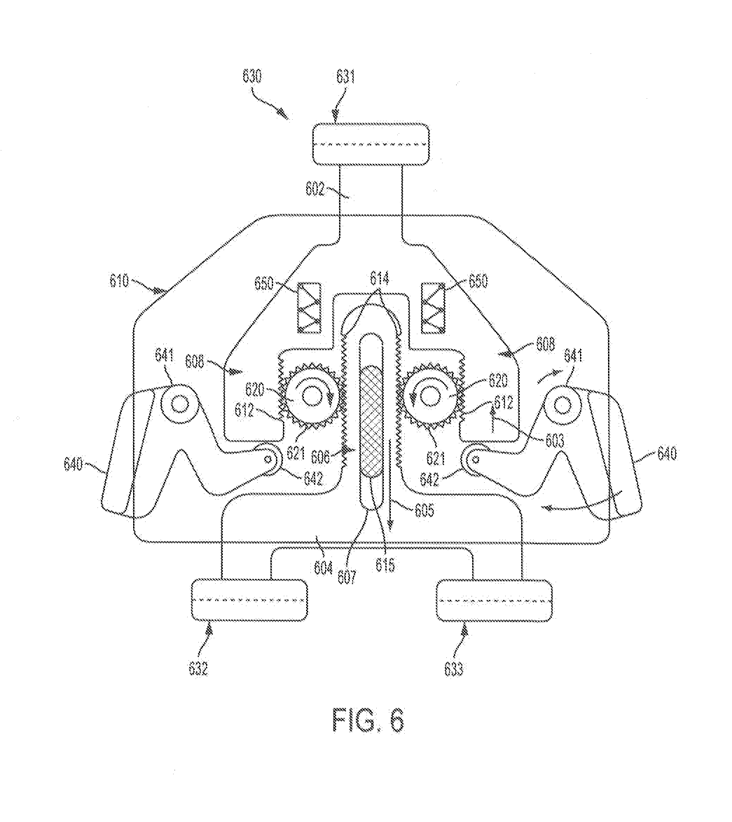

FIG. 6 illustrates a cut-away view of the molded enclosure 610 of an alternative embodiment of a retention system 630, to better show the inner workings of the retention system 630 within the molded enclosure 610. In the embodiment of FIG. 6, the retention system 630 may comprise retention elements 631, 632, and 633 (which may be similar to retention elements 31, 32 and 33 described above). The retention elements 631, 632 and 633 may be mounted to support pieces 602 and 604. In some embodiments, the retention system 630 may comprise a top support piece 602 (or upper frame) and a bottom support piece 604 (or lower frame). The support pieces 602 and 604 may be operable to move vertically within the molded enclosure 610, as shown by arrows 603 and 605 in FIG. 6. In some embodiments, the support pieces 602 and 604 in FIG. 6 may move in opposite directions, i.e. when the top support piece 602 is adjusted upward or away from the molded enclosure 610, the bottom support piece 604 is moved downward and also away from the molded enclosure 610. In other words, the support pieces 602 and 604 may both move away from the molded enclosure 610 or toward the molded enclosure 610. In other embodiments, however, one or more of the retention elements and its support piece might be fixed, such that the adjustment only affects some of the retention elements, and their movements with respect to the fixed retention element(s) might allow for securement of the device.

In the embodiment of FIG. 6, the movement of the support pieces 602 and 604 may be controlled by one or more levers 640 operable to interact with one or both of the support pieces 602 and 604. The lever(s) 640 may comprise bell crank style levers that, when pushed, rotate about a pivot 641, wherein the pivot 641 may be fixed within the molded enclosure 610. The motion of the lever 640 about the pivot 641 may be utilized in many ways, one of which is to push or pull a component that is in contact with the lever. In the embodiment shown in FIG. 6, the movement of the lever(s) 640 may push the top support piece 602 upwards, or outward from the molded enclosure 610, as indicated by arrow 603.

In some embodiments, the top support piece 602 may be biased by one or more springs 650 in a downward direction, such that if the levers 640 are released, the top support piece 602 may move downward, or toward the molded enclosure 610. Such a configuration would ensure that any device mounted within the retention elements 631, 632, and 633 would be securely held until the lever(s) 640 are pressed to move the retention elements outward to release the device. However, in other embodiments, the direction of the motion of the levers 640 and/or springs 650 may be different, wherein the springs 650 may bias one or both of the support pieces against the movement of the lever(s) 640. In other words, when the lever(s) 640 are pushed, the lever(s) 640 may move the support piece(s) to compress the spring(s) 650, and when the lever(s) 640 are released, the spring(s) 650 may bias the support piece(s) back to a resting position. In some embodiments, the levers 640 may comprise rollers 642 that contact the top support piece 602 (although in other embodiments, the rollers might be part of the support piece(s)).

In the embodiment of FIG. 6, the top support piece 602 may comprise teeth 612 that interface with one or more round gear 620, wherein the teeth 621 of the round gear(s) 620 interface with the linear teeth 612 of the top support piece 602. In some embodiments, the gear(s) 620 and/or lever(s) 640 may be considered to be part of a dimension adjustment feature (similar to dimension adjustment feature 40 described above). Additionally, the bottom support piece 604 may comprise teeth 614, wherein the teeth 621 of the round gear(s) 620 also interface with the linear teeth 614 of the bottom support piece 604. In other words, each of the gear(s) 620 would typically be located between the top support piece 602 and the bottom support piece 604 (e.g. contacting the portion of the top support piece 602 and bottom support piece 604 having teeth).

The round gear(s) 620 rotate and provide a reverse motion of the top support piece 602 to the bottom support piece 604. In other words, whenever the top support piece 602 is moving outwardly 603 (moved by the lever(s) 640), the bottom support piece 604 is also moving outwardly but in an opposite direction 605. For example, pressing the lever(s) 640 might move the top support piece 602 upward, while moving the bottom support piece 604 downward (due to interaction with the gear(s) 620). In some embodiments, the movement of the bottom support piece 604 may be guided by a guide bearing 615 (which might ensure linear motion along a specific path).

In the embodiment of FIG. 6, there are two round gears 620. The bottom support piece 604 includes a vertical element 606 (extending along a line from the bottom of the molded enclosure 610 toward the top of the molded enclosure 610, typically the vertical centerline), which has teeth 614 on either side and which engages (with a slot 607) the guide bearing 615 to fix motion of the support pieces 602 and 604 upward and downward. In other embodiments, the guide bearing 615 might instead interact with the top support piece 602. Also, in FIG. 6, the top support piece 602 might include two wing portions 608 on its lower end/side, with a gap in between the wing portions 608. Each wing portion 608 may interact with a lever 640 (for example, contacting a roller 642), and may have teeth 612 on its inner wing surface. The gap between the wing portions 608 may be sized to fit the gears 620 and the vertical element 606 of the bottom support piece 604, while also allowing movement of the bottom support piece 604 during use.

This configuration may allow movement for full extension of the retention elements 631, 632 and 633 to allow for the installation and/or removal of a personal entertainment device (and account for different device sizes). When a personal entertainment device is installed (and the lever(s) 640 released), the springs 650 may bias the retention elements 631, 632, and 633 against the edges of the personal entertainment device, providing a secure retention of the device. Then, to remove the device, the lever(s) 640 may be pushed to extend the support pieces 602 and 604 and therefore the retention elements 631, 632 and 633 (allowing removal of the device).

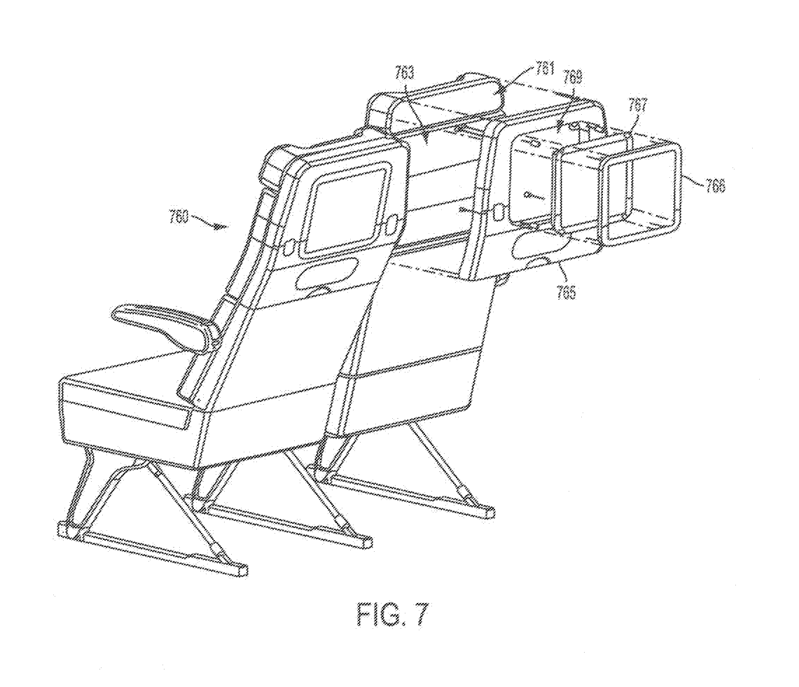

While embodiments above typically would be used in new seats (constructed to have device mounts instead of in-flight entertainment devices), it is also possible to retrofit existing seats (which currently have in-flight entertainment devices mounted in the seat back) with personal entertainment device mounts. FIG. 7 is an exploded view showing exemplary current (existing) seats with in-flight entertainment devices built-in. For example in FIG. 7, a seat 760 might have a recessed portion 763 in seat back 761 allowing for attachment of the in-flight entertainment device 767. Typically, an in-flight entertainment display shroud 765 would fit into the recessed portion 763 of the seat back 761, and the shroud 765 would have an opening 769 operable to retain an in-flight entertainment display 767. In some embodiments, the opening 769 might be a through opening (e.g. with at least a portion of the open extending all the way from the front surface to the rear surface as a through hole), while in other embodiments the opening 769 might merely be a recessed portion sized to fit the in-flight entertainment display 767. Typically, the in-flight entertainment display 767 would be inserted and retained within the opening 769 of the in-flight entertainment display shroud 765. For example, in some embodiments the in-flight entertainment display might be screwed into corresponding threaded holes in the display shroud 765. Often times, such screws (or other retaining features) might be hidden behind an in-flight entertainment display bezel 766 for improved aesthetics.

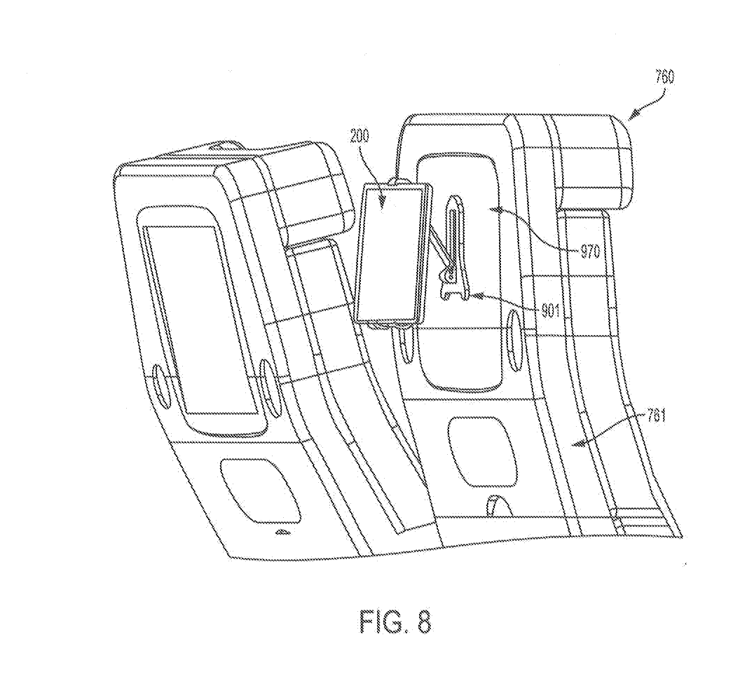

In retrofitting such seats (as shown for example in FIG. 7), the in-flight entertainment display shroud 765 may continue to be used (although the in-flight entertainment display itself would be removed, exposing the opening 769 in the display shroud). In other words, the retrofit may fit and be attached within the existing in-flight entertainment display shroud 765. For example, a retrofit panel (which is typically sized and shaped to fit snugly within the opening 769 of the display shroud 765) may be inserted and retained within the opening 769 of the in-flight entertainment display shroud 765. A device mounting system may be attached to the retrofit panel, for example to allow for retention and/or positioning of a user's personal entertainment device. The device mounting system may include a mount plate which may be removably affixed to the retrofit panel, rotatable bracket elements (for example, for repositioning the device vertically, with respect to distance from the user, and/or with respect to tilt), and retention elements for removably/adjustably holding a personal entertainment device. The device mount may be similar to embodiments described above, and may use a variety of removable attachment options to attach to the retrofit panel. Specific embodiments with different removable attachment means will be described in more detail below with respect to FIGS. 8 to 15. In other embodiments, the device mount might be permanently attached to the retrofit panel.

Typically, in a retrofitting process the in-flight entertainment display bezel 766 and/or in-flight entertainment display 767 would be removed from the in-flight entertainment display shroud 765, exposing the opening 769 in the display shroud. The retrofit panel 970 would be placed/attached/affixed in place in the opening 769 of the display shroud 765. The device mount 901 would typically be removably attached to the retrofit panel 970. For example, a mount plate of the device mount 901 might be removably attached to the retrofit panel 970 (for example using mount buttons operable to be inserted through corresponding/matching apertures in the retrofit panel 970, magnets which may be attracted to ferromagnetic element(s)/panel in the retrofit panel 970, and/or suction cup mounts operable to securely attach to a mount area of the retrofit panel 970). Rotatable bracket elements would typically be affixed to the mount plate (for example using one or more hinges and one or more arms), with one end (e.g. the proximal end) of the bracket elements affixed to the mount plate and the distal end of the bracket elements being attached to the device holder which would comprise retention elements for removably and/or adjustably holding a personal entertainment device. In other embodiments, the device mount 901 might be permanently attached to the retrofit panel 970. Regardless, the use of the retrofit panel 970 within an existing in-flight entertainment display shroud 765 would allow for simple and quick retrofitting of existing seats which currently have in-flight entertainment displays mounted to seat backs.

FIGS. 8 to 15 illustrate three different embodiments of the retrofit panel 970 for personal entertainment device mounting, using three different removable attachment means for fixing the mount plate of the device mount 901 onto the retrofit panel. These illustrated embodiments are merely exemplary, and other removable attachment means (or in some instances permanent attachment means) might also be used in other embodiments, all of which are intended to be included within the scope of this disclosure. Nevertheless, the disclosed embodiments described below should provide ample detail for persons of skill to understand the broader concept included herein.

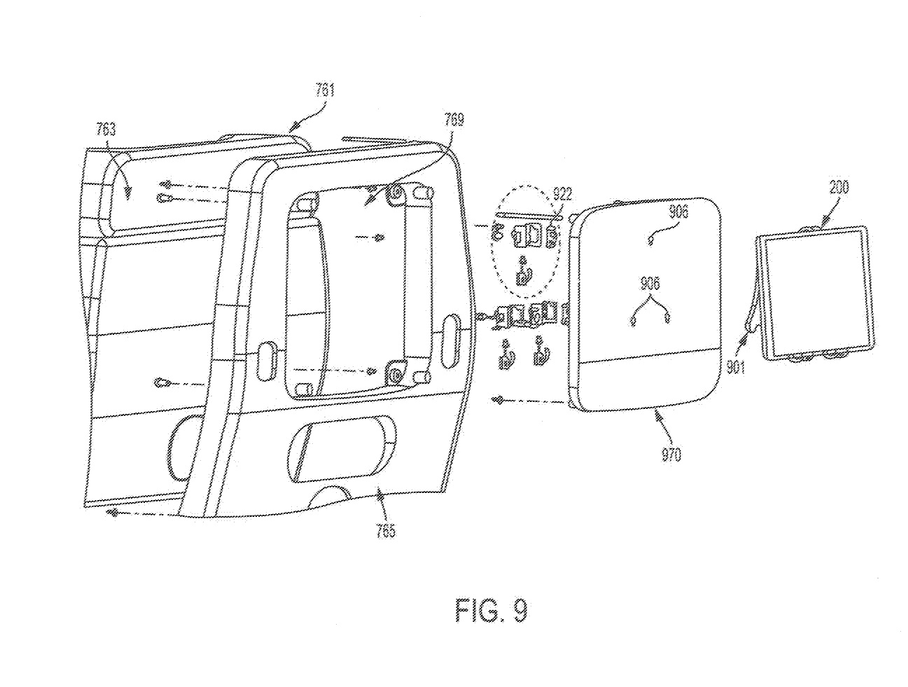

FIG. 8 illustrates a retrofit embodiment in which a retrofit panel 970 is fitted in place within the opening 769 in the in-flight entertainment display shroud 765 on a seat back 761. Removably attached to the retrofit panel 970 is a device mount 901 for removably and adjustably holding a personal entertainment device 200. FIG. 9 illustrates an exploded view of the retrofit embodiment of FIG. 8. FIG. 9 clearly illustrates the display shroud 765 which attaches to the seat back 761 and has an opening 769. FIG. 9 further illustrates the retrofit panel 970 and the device mount 901. The retrofit panel 970 of FIG. 9 is configured to fit snugly within the opening 769 in the display shroud 765 (for example, with little to no gap between the retrofit panel and the edge of the opening 769 in the display shroud to 765). The retrofit panel 970 of FIG. 9 typically would be configured to attach securely to the display shroud 765 using existing mounting elements on the display shroud. In FIG. 9, the retrofit panel 970 may be configured for use with a button mounting system for removable attachment of the device mount 901. Thus, the retrofit panel 970 may include mount button receptacles 906 with apertures configured to receive removably locking mount buttons (which might for example be located on the mount plate of the device mount 901). As described above (for example with respect to FIG. 5A) the apertures may have a keyhole shape. Furthermore, each of the button receptacles 906 of the retrofit panel 970 may also comprise an aperture cover 922, which may be biased to close the apertures when no mount button is inserted therein (similar to that described with respect to FIG. 5C).

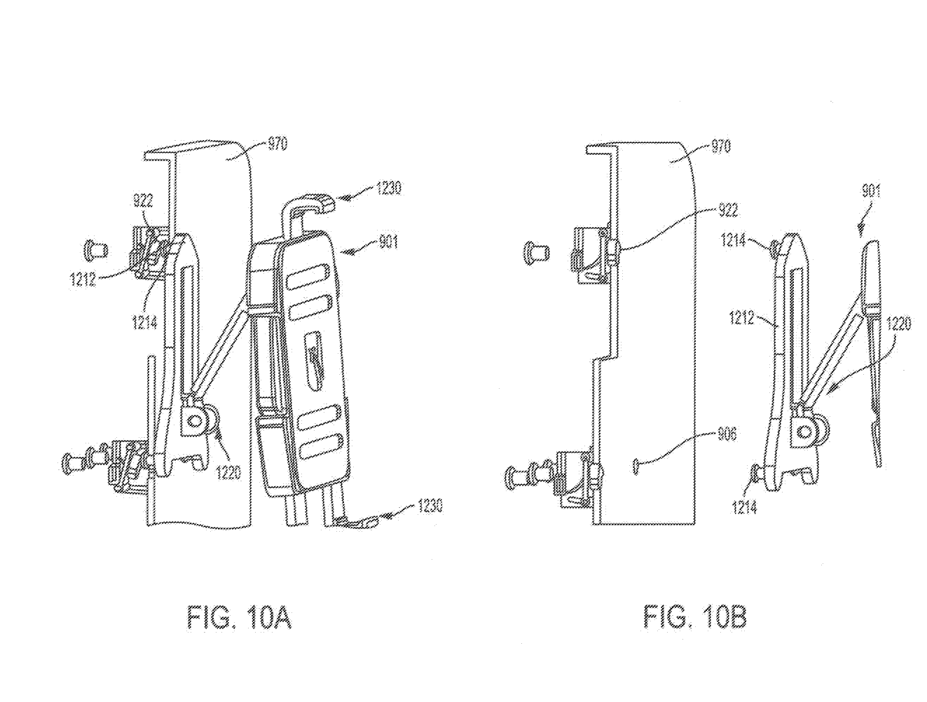

FIG. 9 illustrates the retrofit panel 970 with respect to the display shroud 765 in greater detail. Specifically, the button receptacles 906 may be seen more clearly (for example with respect to their keyhole shape) in the retrofit panel 970 of FIG. 9. Furthermore, FIG. 9 demonstrates an exploded view the aperture cover 922 for the retrofit panel 970. FIGS. 10A and 10B illustrates in further detail the mount button 1214 attachment of the device mount 901 to the retrofit panel 970, with FIG. 10A illustrating in cross-section the removably mounted device mount 901 in place and attached to the retrofit panel 970 and FIG. 10B illustrating an exploded cross-section to better illustrate the apertures and mount buttons 1214 when the device mount 901 is unattached from the retrofit panel 970.

In FIGS. 10A and 10B, the device mount 901 comprises retention elements 1230 for removably/adjustably holding a personal entertainment device, rotatable bracket elements 1220 (typically consisting of one or more arms pivotably linked together and/or to the retention elements and/or to the mount plate) which link the retention elements 1230 to the mount plate 1212 and allow for repositioning of a personal entertainment device 200 which is held by the retention elements 1230 (for example in the vertical direction, in the depth direction with respect to the user or seat back, and/or with respect to tilt), and a mount plate 1212 having one or more mount buttons 1214 to allow for removable attachment of the device mount 901 to the retrofit panel 970 via interaction with the mount button apertures 906. In FIGS. 10A and 10B, the apertures 906 in the retrofit panel 970 may optionally include aperture covers 922. Thus, the retrofit panel 970 of FIGS. 10A and 10B may further include aperture covers 922 for each of the apertures 906. As described above, the aperture covers 922 are biased to a closed position in which they seal the apertures 906 whenever the mount buttons 1214 are not inserted into the apertures 906. Whenever the mount buttons 1214 are inserted into the apertures 906, however, the aperture covers 922 would be pushed back to provide clearance for the mount buttons 1214, allowing mount buttons 1214 to be inserted into the apertures 906 for removable attachment of the device mount 901 to the retrofit panel 970.

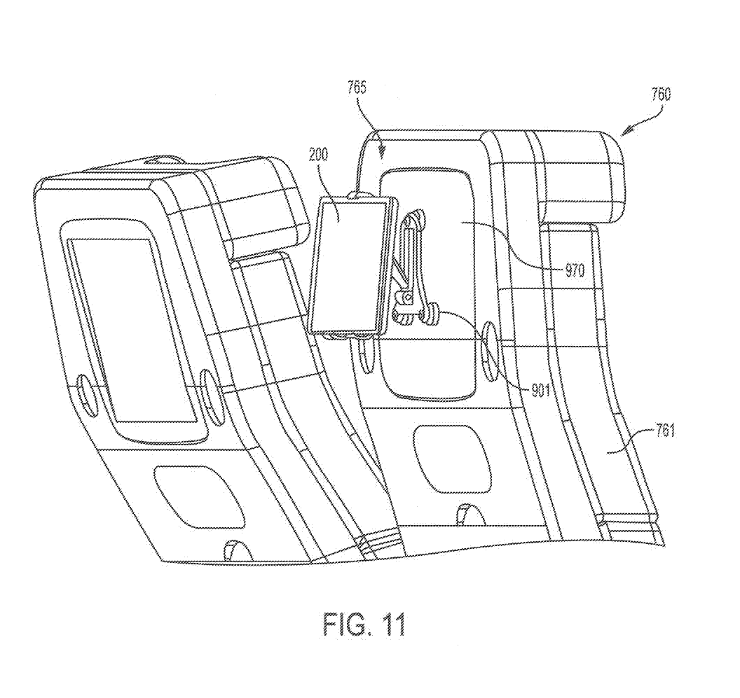

FIGS. 11 to 13 illustrate a second retrofit embodiment which utilizes a magnetic mounting system. The embodiment of FIGS. 11 to 13 is similar in many respects to the embodiment of FIGS. 8 to 10B, for example, with the exception of the removable attachment means for affixing the device mount 901 to the retrofit panel 970. Instead of using a button mount system for such removable attachment, the embodiment of FIGS. 11 to 13 employs a magnetic mounting system (for example using one or more rare earth magnets in conjunction with one or more ferromagnetic elements/panels).

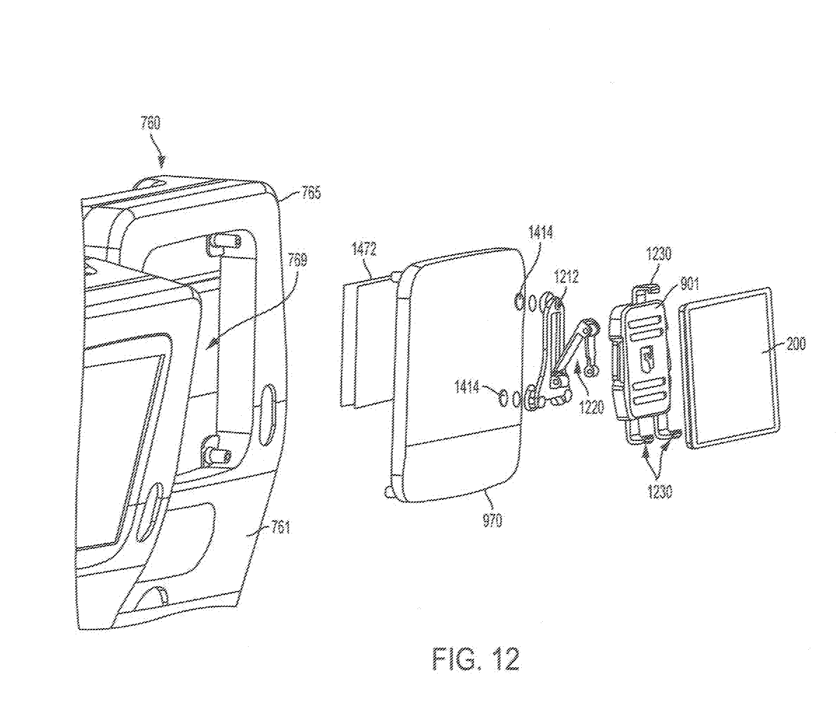

FIG. 11 illustrates a retrofit embodiment in which a retrofit panel 970 is fitted in place within the opening 769 in the in-flight entertainment display shroud 765 on a seat back 761 of a seat 760. Removably attached to the retrofit panel 970 is a device mount 901 for removably and adjustably holding a personal entertainment device 200. FIG. 12 illustrates an exploded view of the retrofit embodiment of FIG. 11. FIG. 12 clearly illustrates the display shroud 765 which attaches to the seat back 761 and has an opening 769. FIG. 12 further illustrates the retrofit panel 970 and the device mount 901. The retrofit panel 970 of FIG. 12 is configured to fit snugly within the opening 769 in the display shroud 765 (for example, with little to no gap between the retrofit panel in the edge of the opening 769 in the display shroud to 65). The retrofit panel 970 of FIG. 12 typically would be configured to attach securely to the display shroud 765 using existing mounting elements on the display shroud. In FIG. 12, the retrofit panel 970 is configured for use with a magnetic mounting system for the device mount 901. Thus, the retrofit panel 970 of FIG. 12 would typically include one or more ferromagnetic elements (for example a ferromagnetic panel 1472, which, in some embodiments, might be a panel of 420 stainless steel). In the embodiment of FIG. 12, a pressure-sensitive adhesive panel might be used to attach the ferromagnetic panel 1472 to the rear surface of the retrofit panel 970 (although other adhesive and other attachment means might also be used to integrate the ferromagnetic panel into the retrofit panel 970). Typically, the exterior of the retrofit panel 970 would be formed thermoplastic, which may help to present a unified aesthetic/image for the seat is a whole (and typically, the retrofit panel 970 would have surface texture similar to that of the seat back).

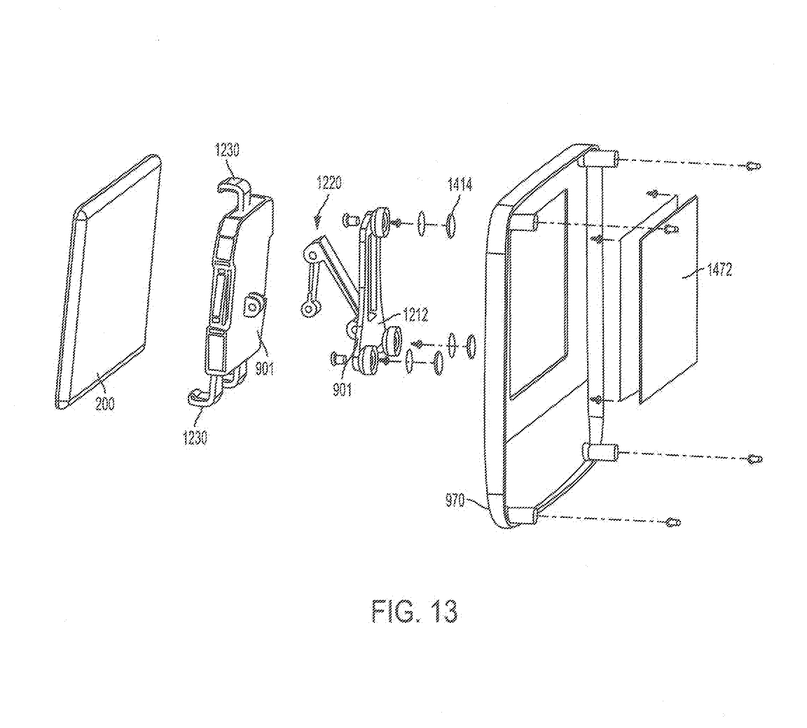

FIG. 13 illustrates in more detail an exploded view showing the rear side of the retrofit panel 970. The retrofit panel 970 of FIG. 13 may have a panel recess on its rear surface (e.g. the surface that will face the seat back), which may be sized based on the dimensions of the ferromagnetic panel 1472 (for example to snugly fit the panel). Thus, in FIG. 13, the pressure-sensitive adhesive panel might be placed under the ferromagnetic panel 1472 as it is inserted into the panel recess in the retrofit panel 970. The device mount 901 of FIG. 13 comprises a mount plate 1212 having one or more (and typically three or more) rare earth magnets 1414, which may be attached to the device mount 901 using pressure sensitive adhesive. Similar to other embodiments described above, the device mount 901 would also include bracket elements 1220 which link retention elements 1230 (for removably holding a personal entertainment device 200) to the mount plate 1212. Thus, the device mount 901 might be removably attached to the retrofit panel 970 using magnetic attraction between the rare earth magnets 1414 in the device mount 901 and the ferromagnetic panel 1472 in the retrofit panel 970. In a typical embodiment, the retrofit panel 970 includes an area free from surface texture so as to increase magnetic retention between the rare earth magnets 1414 and the retrofit panel 970. Typically the number and strength of rare earth magnets to be used on the mount plate 1212 in FIG. 13 and the amount of ferromagnetic material located in or behind the retrofit panel 970 would depend on the desired strength of attachment. Typically, the strength of the rare earth magnets 1414 would not be sufficient to interfere electromagnetically with the personal entertainment device 200, which is to be held in place by the device mount 901.

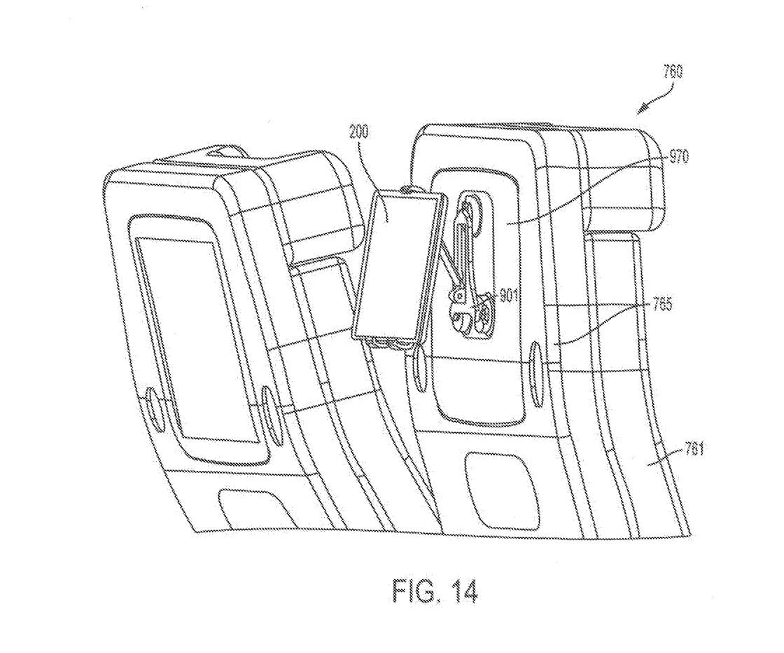

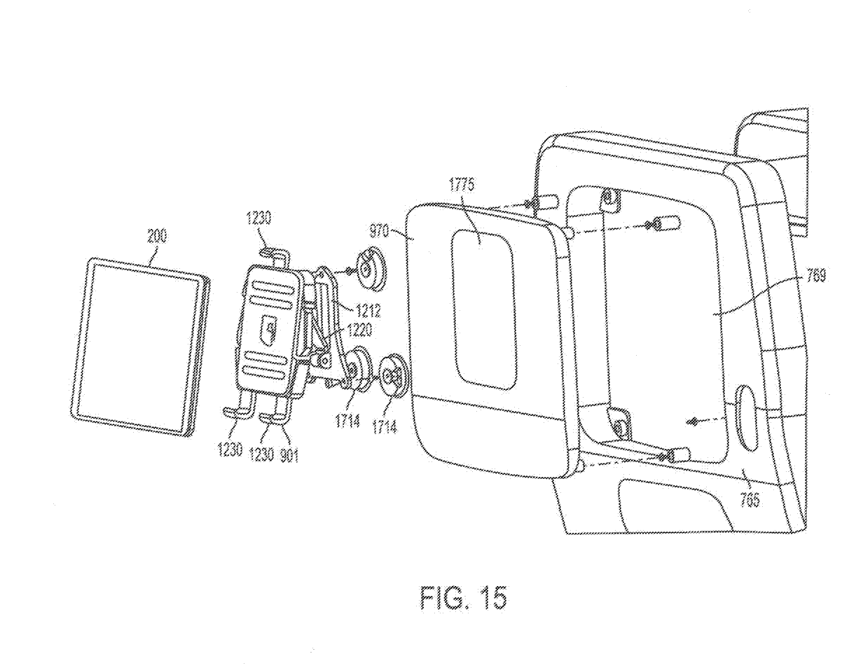

FIGS. 14 and 15 illustrate a third retrofit embodiment which utilizes a suction cup mounting system. The embodiment of FIGS. 14 and 15 is similar in many aspects to the embodiments of FIGS. 8 to 13, for example, with the exception of the removable attachment means for fixing the device mount 901 to the retrofit panel 970. Instead of using either a button mount system or a magnetic mounting system for such removable attachment, the embodiment of FIGS. 14 and 15 employs a suction-cup mounting system.

FIG. 14 illustrates a retrofit embodiment in which a retrofit panel 970 is fitted in place within the opening 769 in the in-flight entertainment display shroud 765 on a seat back 761 of a seat 760. Removably attached to the retrofit panel 970 is a device mount 901 for removably and adjustably holding a personal entertainment device 200. FIG. 15 illustrates an exploded view of the retrofit embodiment of FIG. 14. FIG. 15 clearly illustrates the display shroud 765 which attaches to the seat back 761 and has an opening 769. FIG. 15 further illustrates the retrofit panel 970 and the device mount 901. The retrofit panel 970 of FIG. 15 is configured to fit snugly within the opening 769 in the display shroud 765 (for example, with little to no gap between the retrofit panel in the edge of the opening 769 in the display shroud 765). The retrofit panel 970 of FIG. 15 typically would be configured to attach securely to the display shroud 765 using existing mounting elements on the display shroud. In FIG. 15, the retrofit panel 970 is configured for use with a suction-cup mounting system for the device mount 901. Thus, the retrofit panel 970 of FIG. 15 might comprise a suction-cup mount area 1775 on its exterior/front surface, configured to provide an effective surface for locking suction-cup mounting. By way of example, the mount area 1775 would typically be quite smooth. In some embodiments, the remainder of the exterior/front surface of the retrofit panel 970 would be textured, for example to have a similar texture to that of the seat back. Typically, the exterior of the retrofit panel 970 would be formed thermoplastic, which may help to present a unified aesthetic/image for the seat is a whole.

The device mount 901 in FIG. 15 would include one or more (and typically three or more) locking suction cups 1714 (for example, lever-actuated locking suction cups), which would typically be mounted to the rear/interior surface of the mount plate 1212. As described above with respect to other embodiments, bracket elements 1220 would pivotably connected retention elements 1230 (configured to removably and/or adjustably hold a personal entertainment device 200 in place on the device mount 901) to the mount plate 1212. Thus, the device mount 901 might be removably attached to the retrofit panel 970 via a suction force between the suction cups 1714 and the mount area 1775 of the retrofit panel 970.

As noted above, one or more of the elements of the retrofit system(s) described above may be formed of composite and/or thermoplastic (for example, composite with encapsulating thermoplastic injection molded thereon). In some embodiments, one or more of the thermoplastic elements might be formed simply of thermoplastic (e.g. the same thermoplastic material as the composite material) without any reinforcing fibers, but in other embodiments such elements might be molded with thermoplastic resin (e.g. the same thermoplastic material as the composite material) while having reinforcing fibers dispersed throughout the resin to provide additional strength. It should be noted, however, that any such fibers in thermoplastic resin during injection molding would not have the same precision of orientation and location as the weave of reinforcing fibers located in the composite material.

In some embodiment, some or all of the composite material optionally used in the device mount assembly may be multi-layered (for example, formed of two or more layers of composite). This layering of composites may provide for additional structural support for the element. While some embodiments may require multi-layered composite support throughout the element, in other embodiments one or more layers of composite may be used for most of the element, with additional layer(s) used only in critical areas of the element requiring greater structural support. Typically, the multiple layers of composite may be securely affixed (for example, fused together, as by ultrasonic welding, thermal staking, thermal welding, consolidation, homogeneously affixed, or other such joining means). In some embodiments, the multiple layers of composite may be oriented so that the reinforcing fibers of each layer are oriented differently. By altering the fiber orientation of the layers, the joint composite may provide additional strength in some embodiments.

Some disclosed embodiments may relate to a Thermoplastic Composite Retrofit Panel Assembly to be utilized in the commercial aerospace industry. Typical commercial aircraft seating may include “IFE”, or In Flight Entertainment systems that include an electronic video display installed into the head rest (e.g. upper) portion of an aircraft seat. Such a display is typically facing rearward for the use by the passenger facing forward in a seat directly behind the aircraft seat head rest with the integral display.

IFE is typically separate from the aircraft Passenger Information System which includes strategically located display screens throughout the aircraft cabin to provide important safety and flight information to each passenger. In some cases, the safety and flight information may also be provided to the individual displays simultaneously as well. During times when there are no passenger safety or flight information messages displayed, the display screen may provide some form of entertainment such as a full length movie, pre-recorded network presentations, games or a flight monitor video showing current aircraft speed, altitude and aircraft position in relation to the flight time. Typically, these options would be passenger selectable and specific to the individual passenger position.

Such IFE displays generally might be contained in a Video Display Shroud. Such a shroud would provide suitable mounting and protection to the display. Typically, such a shroud would comprise an aperture or opening or recess where the IFE display may be positioned and suitable means to retain the display would be provided. The display shroud aperture may be configured as a flush type, where the front face of the IFE display resides flush with the outer surface of the shroud, or a recessed type, where the IFE display is recessed below the outer surface of the shroud. In any case, suitable mounting apertures typically would be integral to the shroud and IFE display mounting fasteners, installed through the mounting apertures into the IFE display housing, may properly secure the display to the shroud. A frame system may also be integrated into the installation to provide additional support and retention.

The Video Display Shroud may further comprise apertures for electronic interconnection ports such as USB Charging Connection Port and Video/Audio I/O Ports for use by the passenger.

The Video Display may also be integrated into a full length Seat Back component, such that the upper portion of the Seat Back (IFE Display Area) would be integral to the balance of the Seat Back, creating one homogenous Seat Back Panel component.

IFE systems are not installed in all commercial aircraft. Passengers may then either utilize their own personal entertainment devices or derive entertainment via the passenger information system display which may provide some form of entertainment with limited field of views and audio capture. This form of entertainment is not passenger selectable.

Typically, such passengers who utilize their own personal entertainment devices might conventionally be limited to where these devices can be stowed and used due to the limited amount of space provided to each passenger. Such passengers may hold their entertainment devices, place the device upon the food tray table when food/beverage items are not present, or simply not use their devices during times when food/beverages are present due to the lack of available space. In some cases, the passenger may try to accommodate all actions of eating, drinking and viewing the personal entertainment device simultaneously with limited success.

Typical IFE systems would be comprised of a multitude of components including individual displays for each seat position, display frame mounting components and hardware, control electronics and control electronic enclosures; and interconnect wires throughout the aircraft electrically connecting the total IFE system to the IFE control system. The conventional IFE System, as a complete system, tends to be substantially heavy. Thus, removal of the integral IFE system in aircraft may reduce weight, hence reduce fuel consumption. Less weight per aircraft equates to less fuel, which equates to reduced operating costs per aircraft per year. Such removal of IFE may also reduce the cost of an overall interior installation, commonly referred to as a “Ship Set” due to the elimination of the costly IFE system components and the costs of seat components modified to accept the IFE system.

Unfortunately, mere removal of the IFE display from a conventional, existing shroud would leave a large unsightly visible aperture/opening. Such mere removal of the IFE system might provide a solution to reduce aircraft weight, operating costs and ship set installation costs, but it does not provide a solution to the lack of available space for the use and stowage of personal entertainment device.

A previous invention such as the Reliant Worldwide Plastics, LLC, (RWP) Personal Entertainment Device Mount Assembly (PEDM—as set forth in a previous provisional application 62/002,594 which is co-owned), resolves the lack of available space afforded to the passenger by providing a means to securely retain a passenger's personal entertainment device, by installing or docking the personal entertainment device into the PEDM and subsequently installing the PEDM into a new shroud or seat back panel configured with apertures that accept the RWP PEDM. The original RWP PEDM product typically required the installation of a new shroud or seat back panel.

Commercial airlines who desire a low cost alternative to the total replacement of the IFE display shrouds or seat back panels for a complete ship set are somewhat at a disadvantage. It would be advantageous to provide a low alternative to those with limited resources with the desire to reduce weight, operating and ship set installation costs by the means mentioned above. The present retrofit system(s) may provide this additional benefit.

As stated previously, some disclosed embodiments may relate to a Thermoplastic Composite Retrofit Panel Assembly for use in the commercial aerospace industry. The retrofit panel assembly would be installed into the IFE display video shroud aperture created by the removal of the IFE display (e.g. the retrofit would work within the pre-existing shroud).

In one embodiment, the retrofit panel assembly might be comprised of a thermoplastic injection molded panel assembly physically configured per each individual application. Size and geometry shape of the retrofit panel would be specific and compatible with the size and geometry of the aperture/opening in the shroud creating by the display removal. The subsequent installation of the retrofit panel device would result in a matching geometry, color and texture to that of the existing display shroud, and unchanged adjacent interior components.

Some embodiments of such a retrofit panel assembly might further be comprised of at least one suitably located Mounting Button aperture that is compatible with a Personal Entertainment Device Mount (PEDM) Device Mount-to-Retrofit Panel Assembly. The mounting button aperture(s) may further be comprised of a pivoting spring-loaded mounting button aperture cover which would deploy rotationally during the installation of a PEDM into the retrofit panel assembly, and returns to the initial position upon removal of the PEDM. The thermoplastic injection molded retrofit panel assembly typically complies to FAR 25.853 and OSU55/55, with integral PEDM mounting button apertures and integral spring loaded aperture covers providing an assembly that meets the minimum performance requirements of the application.

In an additional embodiment, the retrofit panel assembly may be void of PEDM mount button apertures and aperture covers. The panel instead might be comprised of an integral magnetic metallic panel compatible with integral magnets of a PEDM. The metallic panel location typically would be internal to the outer surface of the retrofit panel, not visible or contactable to the user. Material type and thickness of the magnetic metallic panel would be application specific. The thermoplastic injection molded retrofit panel assembly typically would comply to FAR 25.853 and OSU55/55, with an integral magnetic metallic panel, internal to the outer surface of the retrofit panel providing an assembly that meets the minimum performance requirements of the application.

In an additional embodiment, the retrofit panel assembly may be void of PEDM mount button apertures and aperture covers (or magnetic elements). The panel instead may be comprised of an integral suitable outer surface area compatible with integral suction type mounts of a PEDM. The suitable outer surface geometry, dimension and surface condition would tend to be application specific. The suction mounts of a PEDM typically would be application specific to accommodate the required load of a personal entertainment device. The thermoplastic injection molded retrofit panel assembly typically complies to FAR 25.853 and OSU55/55, with an integral outer surface area compatible with suction type mounts of a PEDM providing an assembly that meets the minimum performance requirements of the application.

In some embodiments, the retrofit panel assembly may further be comprised of an integral formed thermoplastic encapsulated carbon or glass reinforced composite element with an injection molding reinforced thermoplastic support structure, further integrated into a thermoplastic injection over-molded retrofit panel cover element providing a thermoplastic homogenous assembly. The composite element may further be comprised of thermally formed and consolidated thermoplastic encapsulated unidirectional or weave carbon or glass reinforcing fiber composite configured to meet the geometric configuration of the display shroud aperture and adjacent componentry. The composite element may further be comprised of thermoplastic injection molded carbon or glass chopped fiber reinforced support structures which are injection molded homogenously attached to the thermoplastic encapsulated unidirectional or weave carbon or glass reinforced composite element creating an integral thermoplastic support structure. The integral thermoplastic support structure may further be comprised of application specific support rib structures, mounting features and threaded insert mounting bosses.

In some embodiments, the thermoplastic support structure may further be comprised of integral injection molded thermoplastic positioning system spire elements that provide repeatable positioning of the support structure to an injection mold tool cavity during the injection over-mold process, providing a repeatable consistent positional placement of the thermoplastic encapsulated reinforced fiber composite integral to the arm rest body thereby ensuring consistent load requirement performance. The retrofit panel assembly may further be comprised of an integral thermoplastic injection over-mold process, integrating the thermoplastic composite element with integral thermoplastic support structure elements to the retrofit panel assembly creating a homogenous attachment at all interface/mating surfaces and through the apertures of the support structure. The support structure may further comprise a plurality of apertures provided through at least one wall section of the composite element. The apertures might provide a pathway for thermoplastic resin material of the retrofit panel over-mold process to flow through and about the composite element and support structure, and injection the over-molded retrofit panel providing additional connective homogenous elements. The thermoplastic injection over-mold process may further be comprised of the thermoplastic injection over-mold material encapsulating at least a portion of thermoplastic composite support structure, or fully encapsulating the thermoplastic composite support structure entirely, based upon the requirement of the given application. The thermoplastic injection molded retrofit panel assembly typically complies to FAR 25.853 and OSU55/55, with integral formed thermoplastic encapsulated uni-directional or weave carbon or glass reinforced composite element integrated with a thermoplastic injection molded carbon or glass chopped fiber reinforced support structure and integral thermoplastic positioning spire elements and a thermoplastic injection over-molded retrofit panel element providing a high strength-to-weight ratio that meets the minimum performance requirements of the application.

Some embodiments may also be free of the PEDM mounting button aperture and aperture covers, with integral magnetic metallic panel, or integral outer surface compatible for use with suction mounting devices of a Personal Entertainment Device Mount (PEDM) instead.

Disclosed embodiments may provide a low cost alternative for the removal of systems within a commercial aircraft interior by providing a means to cover an unsightly aperture created by the removal of the IFE display from a IFE video shroud. Disclosed embodiments typically would be compatible with all existing video display shrouds and would thus provide the continued use of an existing IFE video shroud with minimal part and labor costs. Disclosed retrofit embodiments typically would be compatible with Personal Entertainment Device Mounts of all varieties, thereby providing a suitable resolution to the lack of available space provided to the passenger. Disclosed embodiments may be comprised of chemical and molecular compatible thermoplastics resins throughout the assembly creating an infinite number of homogenous connective attachments that provide additional consistent strength, dimensional stability and rigidity. Disclosed embodiments typically will meet FAR 25.853 and OSU55/55 throughout the tray table assembly. Disclosed embodiments may also reduce the current weight of a commercial airline interior ship set by the use of high strength to weight ratio thermoplastic materials and composites.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow, that scope including all equivalents of the subject matter of the claims. In the claims, any designation of a claim as depending from a range of claims (for example #-##) would indicate that the claim is a multiple dependent claim based of any claim in the range (e.g. dependent on claim # or claim ## or any claim therebetween). Each and every claim is incorporated as further disclosure into the specification and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as comprises, includes, and having should be understood to provide support for narrower terms such as consisting of, consisting essentially of, and comprised substantially of. Use of the term “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A retrofit mount assembly for a personal entertainment device, the retrofit mount assembly comprising:
a retrofit panel coupled to a seat back;
a mount plate removably coupled to the retrofit plate;
a rotatable bracket element coupled to the mount plate;
an enclosure coupled to the rotatable bracket element, the enclosure having a plurality of adjustable retention members slidably disposed therein; and
at least one retention member of the plurality of adjustable retention members being linearly adjustable to facilitate receipt of a personal device by the enclosure.

2. The retrofit mount assembly of claim 1, wherein the rotatable bracket comprises a plurality of articulatable linkages.

3. The retrofit mount assembly of claim 2, wherein the plurality of articulatable linkages facilitate positional adjustment of the enclosure.

4. The retrofit mount assembly of claim 1, wherein the mount plate comprises a mounting button that engages an aperture formed in a back of the retrofit plate.

5. The retrofit mount assembly of claim 4, wherein a spring-biased door covers the aperture when the mounting button is removed.

6. The retrofit mount assembly of claim 1, wherein at least one magnet removably secures the mount plate to the retrofit panel.

7. The retrofit mount assembly of claim 6, wherein the retrofit panel comprises at least one ferromagnetic element.

8. The retrofit mount assembly of claim 6, wherein the at least one magnet comprises three rare Earth magnets.

9. The retrofit mount assembly of claim 7, wherein the ferromagnetic element is a ferromagnetic panel.

10. The retrofit mount assembly of claim 8, wherein the ferromagnetic panel is coupled to the retrofit panel via a pressure sensitive adhesive panel.

11. The retrofit mount assembly of claim 1, wherein at least one suction cup removably secures the mount plate to the retrofit panel.

12. The retrofit mount assembly of claim 11, wherein the at least one suction cup comprises three lever actuated locking suction cups.

13. A method of assembling a retrofit mount assembly for a personal entertainment device, the method comprising:
securing a retrofit panel to a seat back;
removably attaching a mount plate to the retrofit panel, the mount plate being coupled to an enclosure via a rotatable bracket; and
adjusting a retention member to facilitate receipt of the personal entertainment device into the enclosure.

14. The method of claim 13, wherein the attaching comprises engaging at least one button on the mount plate with a corresponding aperture on the retrofit panel.

15. The method of claim 13, wherein the attaching comprises engaging at least one suction cup of the mount plate to the retrofit panel.

16. The method of claim 14, wherein the at least one suction cup is a locking suction cup.

17. The method of claim 13, wherein the attaching comprises engaging at least one magnet of the mount plate with the retrofit panel.

18. The method of claim 17, wherein the at least one magnet comprises a rare Earth magnet.

19. The method of claim 17, wherein the at least one magnet engages a ferromagnetic element of the retrofit panel.

20. The method of claim 13, wherein the securing comprises receiving the retrofit panel into a personal entertainment shroud of the seat back.
